(19) United States
(12) Patent Application Publication
(10) Pub. No.: US 2025/0351776 A1
(43) Pub. Date: Nov. 20, 2025

(54) FORAGE HARVEST MACHINES HAVING MOVEABLE ROTOR ASSEMBLY TROUGH PORTIONS

(71) Applicant: Vermeer Manufacturing Company, Pella, IA (US)

(72) Inventor: Luke Mushitz, Mitchell, SD (US)

(21) Appl. No.: 19/130,390

(22) PCT Filed: Nov. 17, 2023
(86) PCT No.: PCT/US2023/080395

§ 371 Date: May 15, 2025

Related U.S. Application Data
(60) Provisional application No. 63/426,209, filed on Nov. 17, 2022.

(51) Int. Cl. A01D 89/00

(52) U.S. Cl. CPC A01D 89/008; A01D 89/002

(57) ABSTRACT

The present invention relates to a forage harvest machine (1) including a crop pick-up (20), a rotor assembly (40) that rotates about a rotor axis (R), and one or more plates (216). The rotor assembly includes a rotor shaft (44), a plurality of teeth (48) attached to the rotor shaft for rotation in a teeth rotation area, and one or more augers (50, 51) for directing crop material inward toward the plurality of teeth. The one or more plates (216) radially outward from the teeth rotation area form a first trough (217, 218) and a second trough (248) in which each of the one or more augers (50, 51) is at least partially disposed, at least one of the first and second troughs being moveable relative to the other trough to adjust sizing of an auger discharge pocket (252), thereby preventing or clearing a plugging state of the rotor.

### CROSS REFERENCE TO RELATED APPLICATIONS

This application claims the benefit of priority to U.S. Provisional Patent Application No. 63/426,209, filed November 17, 2022, the contents and disclosure of which are incorporated by reference herein in their entirety.

### FIELD OF THE DISCLOSURE

The field of the disclosure relates to forage harvest machines and, more particularly, to round balers having a rotor assembly with first and second augers and a moveable stripper backbone assembly.

### DISCUSSION OF ART

Round balers have become an integral part of the agricultural industry and a variety of different types of balers are currently in use. Balers use a crop pick-up device to convey crop material from the ground into the bale formation chamber. A rotor assembly moves the crop material from the crop pick-up device toward the bale formation chamber. In at least some known round balers, the crop pick-up device may be wider than an entrance to the bale formation chamber. In such round balers, the rotor assembly may include one or more augers to move crop material that is outside the width of the entrance to the bale formation chamber laterally inward. Before being incorporated into the growing bale, the crop material must be separated from the rotating components of the rotor assembly.

Variations in crop material being fed into the round baler may cause crop material to plug at the rotor assembly and, in particular, at the one or more augers moving the crop material laterally inward. Thus, a need exists for a rotor assembly for use with a round baler that includes a moveable stripper backbone assembly to facilitate reduced crop material plugging and/or improved clearing of crop material plugging.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a forage harvest machine. The forage harvest machine includes a crop pick-up device, a rotor assembly that rotates about a rotor axis, and one or more plates. The rotor assembly includes a rotor shaft, a plurality of teeth attached to the rotor shaft for rotation in a teeth rotation area, and one or more augers for directing crop material inward toward the plurality of teeth. The one or more plates radially outward from the teeth rotation area form a first trough and a second trough in which each of the one or more augers is at least partially disposed, at least one of the first and second troughs being moveable relative to the other trough to adjust sizing of an auger discharge pocket.

Another aspect of the present disclosure is directed to a forage harvest machine. The forage harvest machine includes a crop pick-up device and a bale formation chamber, the bale formation chamber including an entrance through which crop material picked up by the crop pick-up device is received into the bale formation chamber. The forage harvest machine also includes a rotor assembly that rotates about a rotor axis and a plurality of stripper assemblies connected to a backbone plate assembly. The rotor assembly includes a plurality of teeth. Each of the plurality of stripper assemblies have an opening aligned along a stripper axis. The forage harvest machine further includes a rotor shield that supports the rotor assembly and a pair of guide plates, each of the pair of guide plates being oriented to enable the backbone plate assembly to move relative to the rotor shield.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a side perspective view of a round baler.

FIG. 2 is a side perspective cut-away view of the round baler shown in FIG. 1.

FIG. 3A is a perspective view of a rotor assembly for use with a round baler.

FIG. 3B is a top partial cross-section view of the round baler shown in FIG. 1.

FIG. 3C is a front view of the round baler shown in FIG. 1.

FIG. 4 is a top view of the rotor assembly shown in FIG. 3A.

FIG. 5 is a side view of a stripper assembly for use with a rotor assembly of a round baler.

FIG. 6 is a partial perspective view of the stripper assembly shown in FIG. 5.

FIG. 7 is a perspective view of the stripper assembly shown in FIG. 5.

FIG. 8 is a partial perspective view of the stripper assembly shown in FIG. 5.

FIG. 9 is a schematic side view of an embodiment of a round baler including a rotor assembly.

FIG. 10 is a schematic side view of the round baler the round baler including the rotor assembly shown in FIG. 9.

FIG. 11 is a perspective view of a stripper backbone assembly for use with a round baler.

FIG. 12 is a perspective view of the stripper backbone assembly shown in FIG. 11.

FIG. 13 is a partial perspective view of the stripper backbone assembly shown in FIG. 11.

FIG. 14 is another perspective view of the stripper backbone assembly shown in FIG. 11.

FIG. 15 is a side perspective view of a stripper backbone assembly for use with a rotor assembly.

FIG. 16 is a perspective view of the stripper backbone assembly shown in FIG. 15.

FIG. 16A is another perspective view of the stripper backbone assembly shown in FIG. 15.

FIG. 17 is a schematic view of an embodiment of a round baler including a rotor assembly and a crop material plugging.

FIG. 18 is a schematic view of the rotor assembly shown in

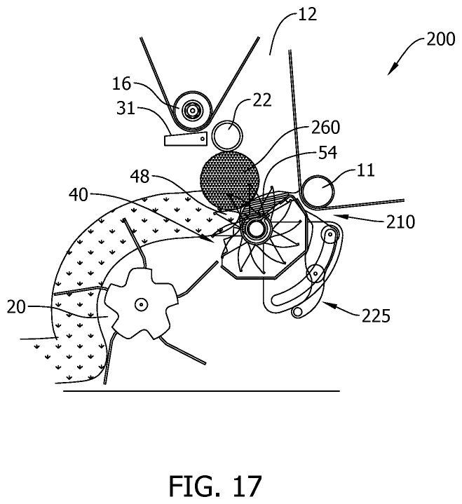

FIG. 17. the rotor assembly being in a first position.

FIG. 19 is a schematic view of the rotor assembly shown in FIG. 17, the rotor assembly being in a second position to facilitate reduced crop material plugging.

FIG. 20 is a perspective front view of a rotor assembly for use with a round baler, the rotor assembly being in a first position.

FIG. 21 is a perspective front view of a rotor assembly for use with a round baler, the rotor assembly being in a second position to facilitate reduced crop material plugging.

Corresponding reference characters indicate corresponding parts throughout the drawings.

### DETAILED DESCRIPTION

There is a need for a rotor assembly for use with a round baler that facilitates reduced crop material plugging and/or improved clearing of crop material plugging.

When introducing elements of various embodiments disclosed herein, the articles “a”, “an”, “the”, and “said” are intended to mean that there are one or more of the elements. The terms “comprising”, “including”, and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

Unless otherwise indicated, approximating language, such as “generally”, “substantially”, and “about”, as used herein indicates that the term so modified may apply to only an approximate degree, as would be recognized by one of ordinary skill in the art, rather than to an absolute or perfect degree. Accordingly, a value modified by a term or terms such as “about”, “approximately”, and “substantially” is not to be limited to the precise value specified. In at least some instances, the approximating language may correspond to the precision of an instrument for measuring the value. Additionally, unless otherwise indicated, the terms “first”, “second”, etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

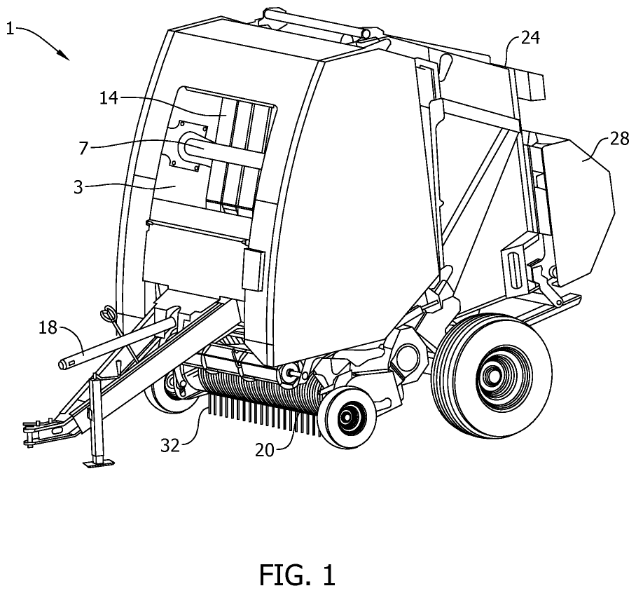

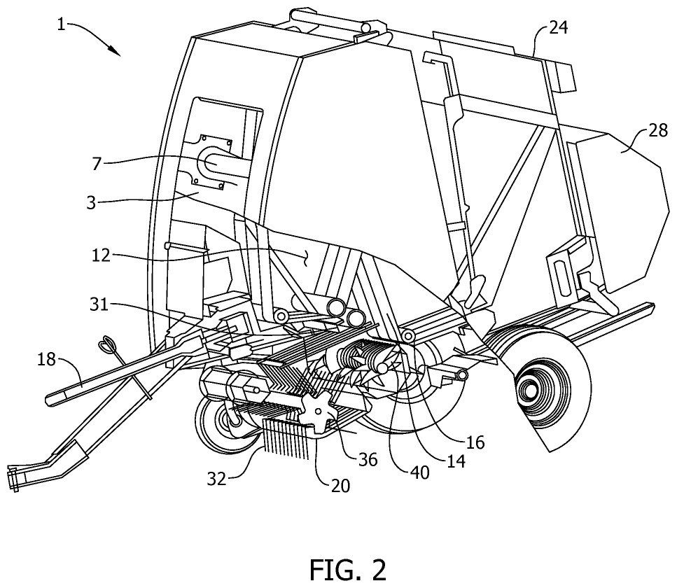

FIGS. 1 and 2 are side perspective views of a round baler 1, a forage harvest machine, for forming round bales of crop material (such as, but not limited to, hay, straw, corn stover, switchgrass, and/or sugar cane). The round baler 1 includes a bale formation chamber 12 (shown in FIG. 2) defined by one or more bale formation belts 14 routed around a plurality of rollers 16. In some embodiments, the round baler 1 may include a plurality of bale formation belts 14. In other embodiments, the round baler may include only one of the bale formation belt 14. The round baler 1 also includes a frame 3, a PTO drive 18, a crop pick-up device 20, one or more belt tighteners 7, and a lift gate 24. The plurality of rollers 16 may include one or more rollers for the one or more bale formation belts 14, including a tailgate roller 11, and one or more rollers for the crop material, including a baler starter roller 22 (shown in 17-19).

After crop material is received by the crop pick-up device 20 and directed into the bale formation chamber 12, as part of a crop pick-up sequence, the crop material is compressed by the one or more bale formation belts 14. Tension is maintained in the bale formation belts 14 by the one or more belt tighteners 7 to compress the crop material into a round bale. Once a full bale (not shown) is formed, the crop pick-up sequence ends, and a wrapping sequence is commenced by a wrapping device 28. The wrapping device 28 is configured to apply one or more layers of wrap material to the outer circumference of the completed bale. Once the wrapping sequence is completed, an ejection sequence is initiated to eject the formed bale from the bale formation chamber 12 when the lift gate 24 is opened. The ejection sequence may be manually or automatically initiated.

The crop pick-up device 20 includes a plurality of tines 32 for transferring crop material from the surface over which the round baler 1 travels and toward the bale formation chamber 12. The crop pick-up device 20 includes a shaft 36 to which the plurality of tines 32 are attached. The plurality of tines 32 rotate with the shaft 36 to pick up crop material and transfer it to a rotor assembly 40 that conveys the crop material from the crop pick-up device 20 towards the bale formation chamber 12. Although the rotor assembly 40 is generally shown and described herein as used with a round baler, such as the round baler 1, the rotor assembly 40 may be used with any forage harvest machine, such as, but not limited to, a loader wagon and/or a silage packer.

The crop pick-up device 20 may also include an actuator to move the crop pick-up device 20 between a raised transport position and a lowered baling position. In the baling position, the crop pick-up device 20 may be positioned for pick-up of crop material within a predefined distance range between the crop pick-up device 20 and the surface over which the round baler 1 travels to accommodate changes in the ground under the round baler 1 during operation. That is, the position of the crop pick-up device 20 may be adjusted while in the baling position to enable pick-up of crop material from inconsistent ground elevations. The crop pick-up device 20 may also include one or more gauge wheels (not shown) to facilitate ground following. the position of which may be adjusted to maintain a predefined distance between ends of the plurality of tines 32 and the ground below the round baler 1. Movement of the crop pick-up device 20 may be independent of movement of the rotor assembly 40.

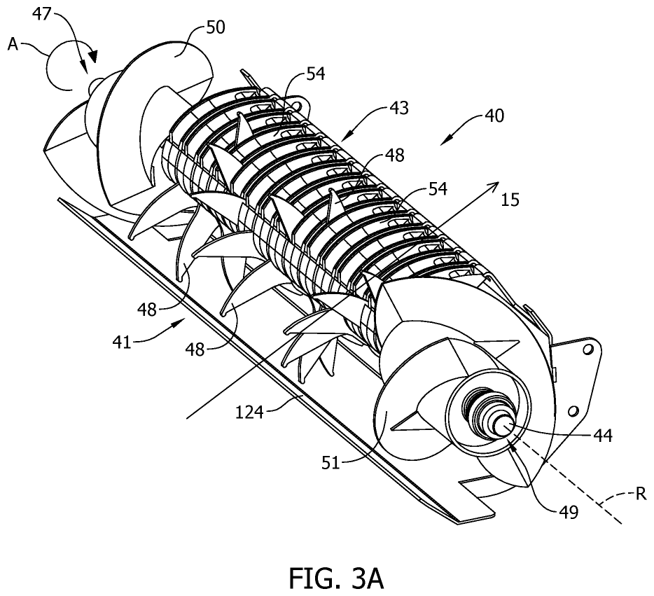

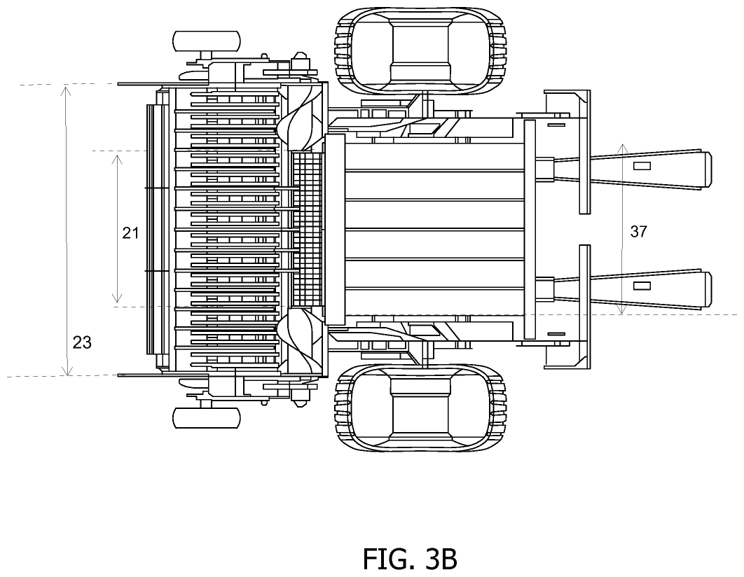

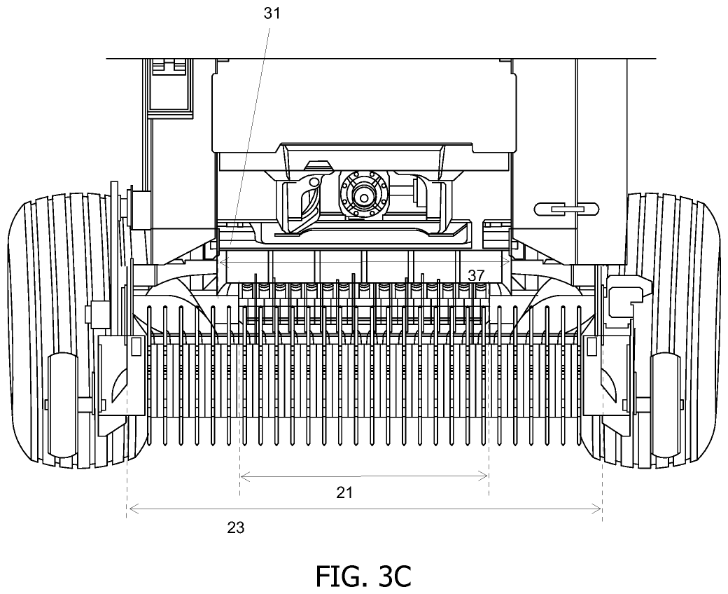

FIG. 3A is a perspective view of the rotor assembly 40 for use with a round baler, such as the round baler 1. The rotor assembly 40 includes a rotor shaft 44 that rotates about an axis of rotation R. The rotor assembly 40 also includes a plurality of teeth 48 attached to the rotor shaft 44 for receiving crop material from the crop pick-up device 20 (shown in FIG. 2) and conveying it toward the bale formation chamber 12. The plurality of teeth 48 rotate in a teeth rotation area. The crop material is moved over the rotor assembly 40 by the plurality of teeth 48, in a configuration that may be referred to as an “over-shot rotor”. The rotor assembly 40 also includes one or more augers to direct crop material received proximate the ends of the rotor assembly (e.g., the ends of the rotor shaft 44) back towards a center of the rotor assembly 40 to be received by the plurality of teeth 48 and conveyed into the bale formation chamber 12. For example, as shown in the Figures, the rotor assembly 40 may include a first auger 50 at a first end 47 of the rotor shaft and a second auger 51 at a second end 49 of the rotor shaft 44 opposite the first end 47.

FIG. 3B is a partial perspective view, and FIG. 3C is a front view, of the round baler 1. After crop material is picked up by the crop pick-up device 20, the rotation of the plurality of tines 32 conveys the crop material towards the bale formation chamber 12 along a primary crop movement direction 15 (shown in FIG. 3B). Generally, the primary crop movement direction 15 is substantially parallel to a longitudinal axis 17 of the round baler 1 (shown in FIG. 3B) as the crop material moves from the crop pick-up device 20 towards an entrance 19 to the bale formation chamber 12 (e.g., a bale formation chamber throat). The entrance 19 to the bale formation chamber 12 is defined between the stripper assemblies 54 of the rotor assembly 40 and the baler starter roller 22 and/or a starter roller scraper 31 (shown in FIGS. 17-19).

In some embodiments, as shown in FIGS. 3B and 3C, the entrance 19 of the bale formation chamber 12 may be a first width 21 and the crop pick-up device 20 may be a second width 23 that is greater than the first width 21. The second width 23 may be defined as a lateral width along the crop pick-up device that includes the plurality of tines 32. Thus, in the illustrated embodiment, crop material picked up by the crop pick-up device 20 laterally outward of the entrance 19 of the bale formation chamber 12 (e.g., crop material picked up laterally outwards of the area defined by the first width 21 and laterally inwards of the area defined by the second width 23) may be moved laterally inward by the first and second augers 50, 51 to be conveyed into the bale formation chamber 12. That is, the first and second augers 50, 51 may move crop material in a secondary crop movement direction 27 substantially perpendicular to the longitudinal axis 17 of the round baler 1 (shown in FIG. 3B) as the crop material is moved laterally inwards towards the entrance 19 to the bale formation chamber 12. The bale formation chamber 12 may be a third width 37 that may be greater than the first width 21 of the entrance 19 of the bale formation chamber 12, as shown in FIG. 3B.

In other embodiments, the first width 21 of the entrance 19 of the bale formation chamber 12 may be substantially the same as the second width 23 of the crop pick-up device 20. In still other embodiments, the first width 21 of the entrance 19 of the bale formation chamber 12 may be less than the second width 23 of the crop pick-up device 20.

The movement of crop material in multiple directions proximate the entrance 19 to the bale formation chamber 12 (such as, but not limited to, movement in the primary crop movement direction 15 substantially parallel to the longitudinal axis 17 into the bale formation chamber 12 and movement in the secondary crop movement direction 27 substantially perpendicular to the longitudinal axis 17 laterally inwards towards the entrance 19 of the bale formation chamber 12) may cause plugging of crop material at the rotor assembly 40. For example, the movement of crop material by the first and second augers 50, 51 may increase the volume of crop material proximate the entrance 19 to the bale formation chamber 12, increasing the probability of crop material plugging occurring.

An innermost portion of each of the first and second augers 50, 51 may be positioned proximate outer edges of the entrance 19 of the bale formation chamber 12. In some embodiments, the innermost portion of the first and second augers 50, 51 may extend laterally inwards of the outer edges of the entrance 19 of the bale formation chamber 12, such as shown in FIG. 3C. In other embodiments, the innermost portion of the first and second augers 50, 51 may extend laterally inwards to align with the outer edges of the entrance 19 of the bale formation chamber 12. In still other embodiments, the first and second augers 50, 51 may extend laterally inwards such that the innermost portions of the first and second augers 50, 51 is positioned laterally outwards of the outer edges of the entrance 19 of the bale formation chamber 12.

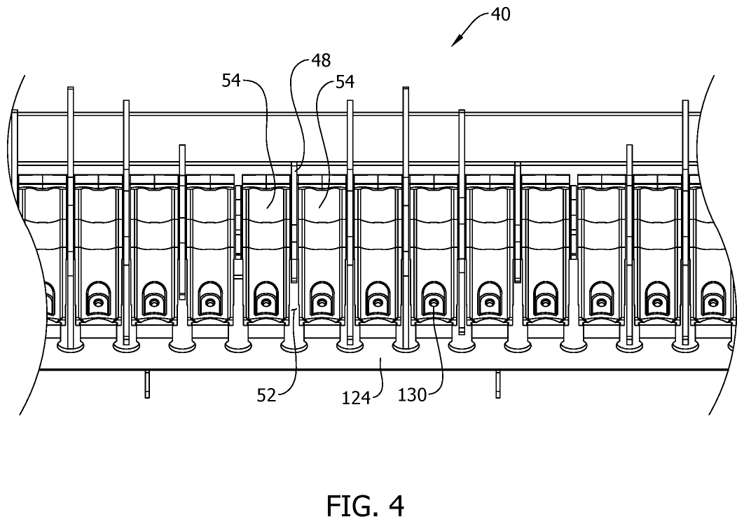

FIG. 4 is a top view of the rotor assembly 40. The rotor assembly 40 includes one or more stripper assemblies 54 spaced along the rotor shaft 44. As the plurality of teeth 48 rotate about the axis of rotation R in the direction indicated by arrow A in FIG. 3A, each of the plurality of teeth 48 passes through a space 52 (shown in FIG. 4) formed between adjacent stripper assemblies 54. A first side 41 of the rotor assembly 40 is oriented towards a front of the round baler 1 and a second side 43 of the rotor assembly 40 is oriented towards a back of the round baler 1. Thus, the plurality of teeth 48 engage the crop material located above the rotor shaft 44 to convey the crop material towards the bale formation chamber 12 and the stripper assemblies 54 remove crop material from the plurality of teeth 48 to incorporate it into the growing bale of crop material.

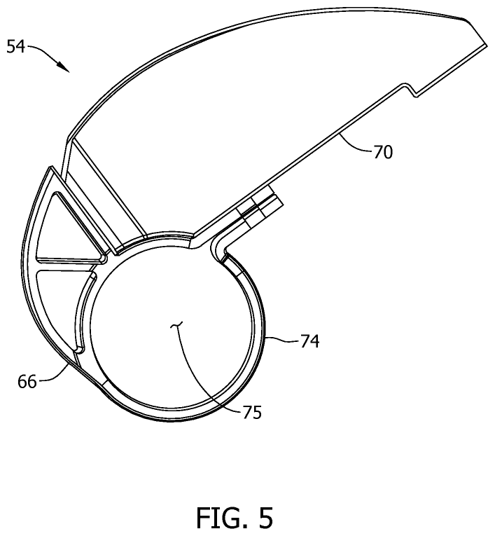

FIG. 5 is a side view of the stripper assembly 54 for use with a rotor assembly, such as the rotor assembly 40. The stripper assembly 54 includes a head section 66 and a tail section 70 removably attached to the head section 66. As used herein, “removably attached” is intended to exclude embodiments in which the parts are integral (e.g., molded as one piece) and is intended to include embodiments in which the parts are attached by fasteners, self-fastening features, or the like.

The head section 66 of the stripper assembly 54 includes a collar 74 oriented to attach the stripper assembly 54 to the rotor shaft 44 (shown in FIG. 3A). The rotor shaft 44 extends through an opening 75 formed by the collar 74. Generally, the opening 75 is sized to permit the rotor shaft 44 to slide axially and prevent the stripper assembly 54 from fracturing upon misalignment with one or more of the plurality of teeth 48. The stripper assembly 54 is fitted onto the rotor shaft 44 via the opening 75. The opening 75 may be sufficiently large to prevent friction but may fit sufficiently close enough to allow the stripper assembly 54 to be supported by the rotor shaft 44.

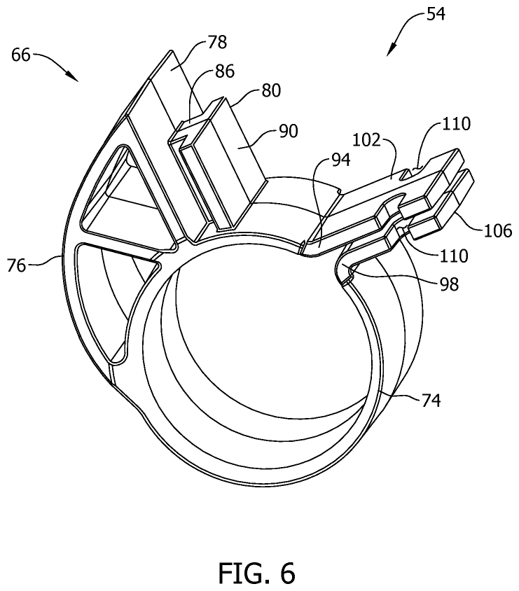

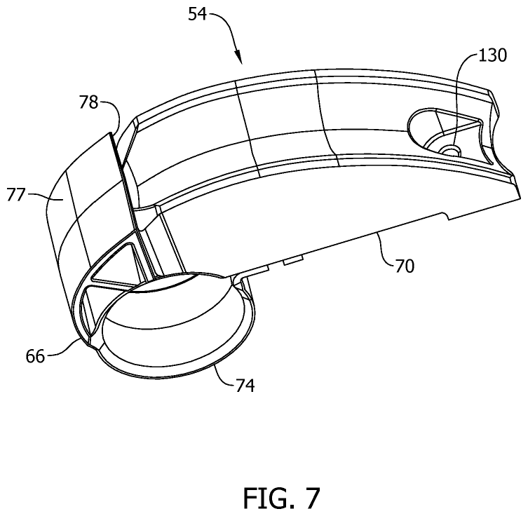

FIG. 6 is a partial perspective view, and FIG. 7 is another perspective view, of the stripper assembly 54. The head section 66 of the stripper assembly 54 includes an arcuate segment 76 that extends outward from the collar 74. The arcuate segment 76 has an outer surface 77 (shown in FIG. 7) that extends from the collar 74 to a sidewall 78.

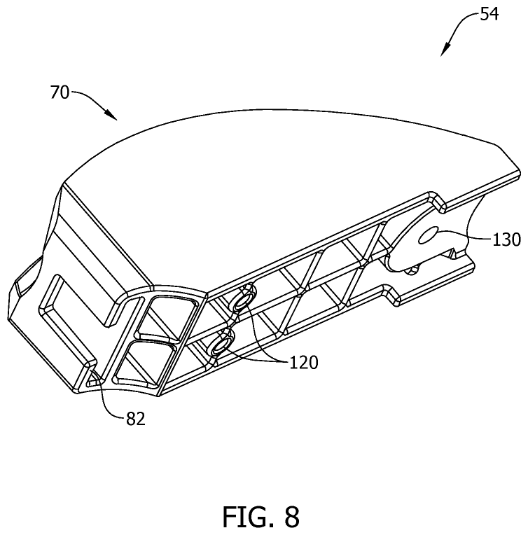

In some embodiments, the head section 66 may include a tab 80 (shown in FIG. 6) for mating with a mounting member 82 (shown in FIG. 8) of the tail section 70. In other embodiments, the tail section 70 may include the tab 80 and the head section 66 may include the mounting member 82. The tab 80 is sized and shaped to be received in the mounting member 82 (i.e., within a chamber formed within the mounting member 82) to attach the head section 66 of the stripper assembly 54 to the tail section 70 of the stripper assembly 54. The tab 80 may include a leg 86 that extends from the sidewall 78 of the head section 66 and a spanning member 90 positioned at an end of, and at an angle to, the leg 86. The spanning member 90 may be arranged at an angle of approximately 90° to the leg 86 to extend substantially perpendicular to the leg 86.

The collar 74 of the head section 66 includes a first end 94 and a second end 98. The first end 94 and the second end 98 are brought into contact to close the collar 74. The first end 94 and the second end 98 are also capable of being separated (i.e., effectively opening the collar 74) to facilitate placement of the collar 74 around the rotor shaft 44 (shown in FIG. 3A). The head section 66 includes a first elongate fastening member 102 that extends from the first end 94 and a second elongate fastening member 106 that extends from the second end 98.

FIG. 8 is a partial perspective view of the stripper assembly 54. The first elongate fastening member 102 and the second elongate fastening member 106 are attached to the tail section 70 (shown in FIG. 7) of the stripper assembly 54 by inserting a fastener (not shown) through recesses 110 formed in the first and second elongate fastening members 102, 106 and through an aperture 120 formed in the tail section 70 of the stripper assembly 54, adjoining the first end 94 and the second end 98 of the collar 74 of the head section 66 together.

The stripper assembly 54 generally is not hinged and may be attached to the rotor shaft 44 (shown in FIG. 3A) by methods that do not involve closing a hinged connection around the rotor shaft 44. In the illustrated embodiment, the head section 66 is formed (e.g., molded) such that the first and second ends 94, 98 of the collar 74 may be brought together into contact with each other. The first and second ends 94, 98 of the collar 74 may be separated to place the collar 74 around the rotor shaft 44 (shown in FIG. 3A) by forcing the first and second elongate fastening members 102, 106 apart and slipping the head section 66 over the rotor shaft 44. Once in place, the inherent spring bias associated with the collar 74 brings the first and second elongate fastening members 102, 106 together. The stripper assembly 54 may be constructed of any suitable material and are generally formed by molding a polymer in the desired shape.

As shown in FIG. 3A, the rotor assembly 40 may include a rotor shield 124 that provides structural support for the rotor assembly 40 and facilitates the collection of crop material that falls below the stripper assemblies 54 to reduce the amount of crop material that falls back to the ground below the round baler 1. The rotor shield 124 partially surrounds an outer arc of rotation of the plurality of teeth 48 of the rotor assembly 40. Each stripper assembly 54 is attached to the rotor shield 124 via the respective tail section 70 by use of a fastener (not shown) received through an opening 130 (shown in FIG. 4) of the tail section 70. A length of the tail section 70 of the stripper assembly 54 may vary depending on the size and/or the model of forage harvest machine that the stripper assembly 54 is being used with. For example, the length of the tail section of the stripper assembly 54 may be longer for larger forage harvest machines, such as a larger round baler.

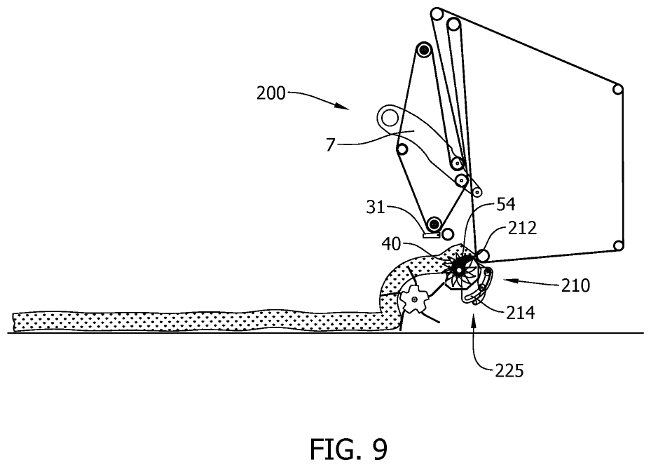

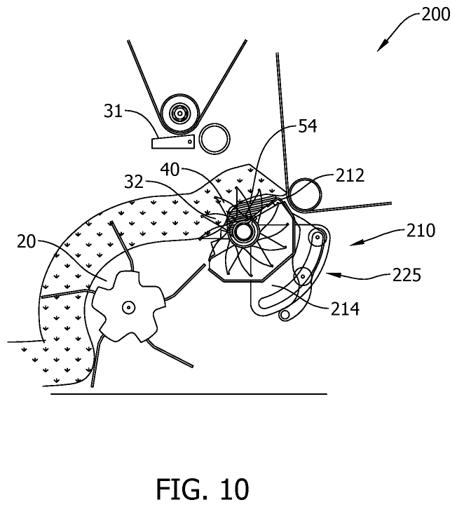

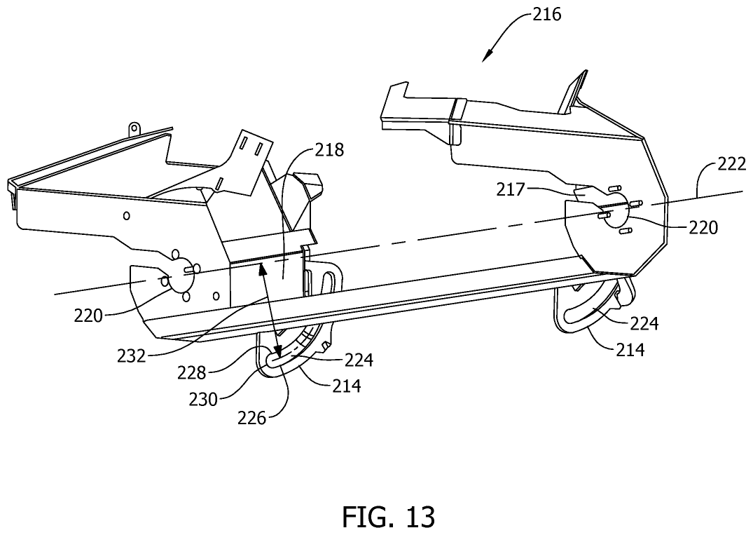

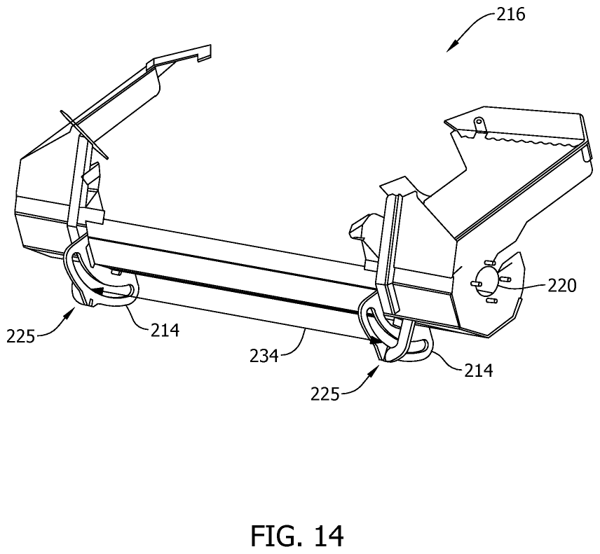

FIGS. 9 and 10 are schematic side views of another embodiment of a round baler 200. The round baler 200 illustrated in FIG. 9 is similar to the round baler 1 (shown in FIGS. 1-8), with the differences noted below, and as such, the same reference numbers for the same components are used in FIG. 9 as were used in FIGS. 1-8. The rotor assembly 40 of the round baler 200 includes the first auger 50 and the second auger 51. Additionally, a portion of the frame 3 of the round baler 200 forms a rotor shield 216 (shown in FIGS. 13 and 14), formed from one or more plates, having a first trough 217 and a second trough 218 radially outward from the teeth rotation area of the plurality of teeth 48 of the rotor assembly 40. The first auger 50 is at least partially positioned within the second trough 218 and the second auger 51 is at least partially positioned within the first trough 217.

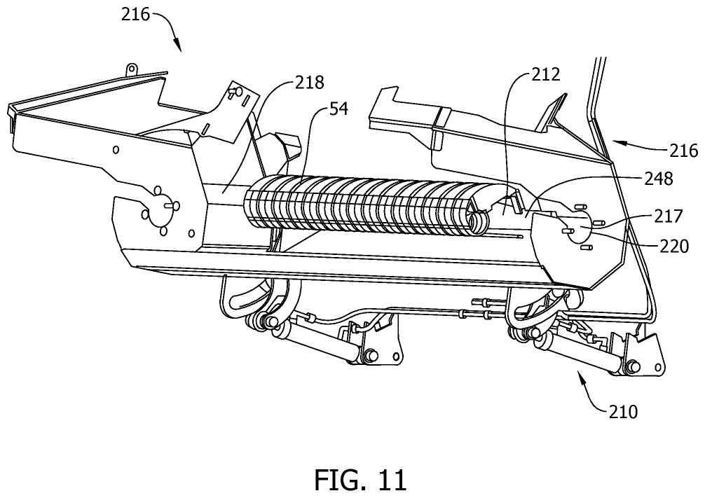

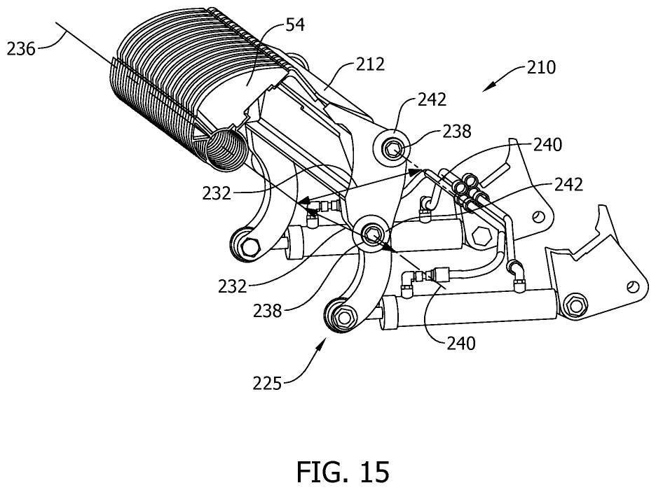

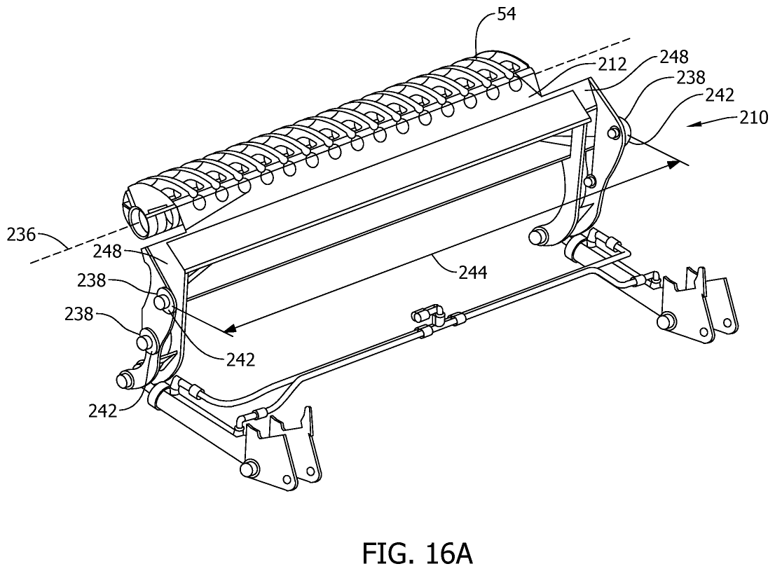

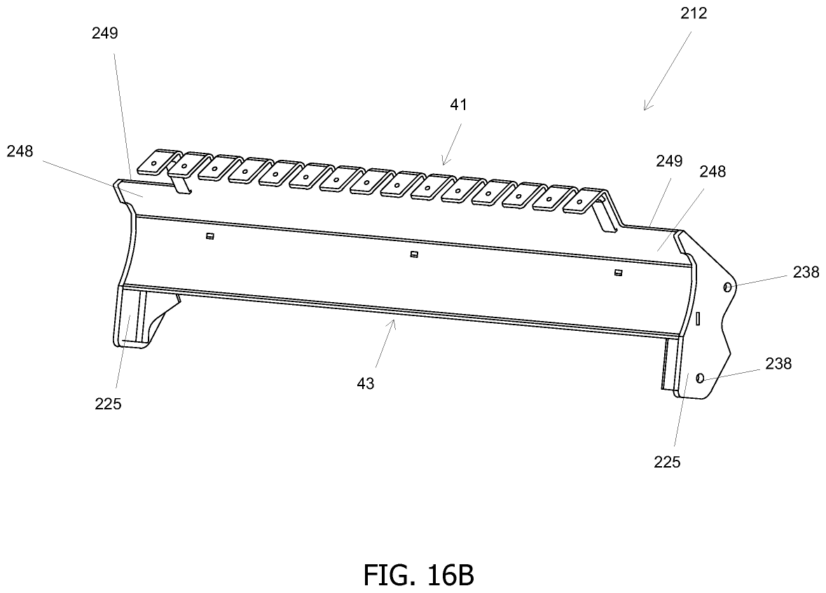

The rotor shield 216 provides structural support for attachment of the stripper backbone assembly 210 and the rotor assembly 40. The stripper backbone assembly 210 includes a backbone plate assembly 212 (shown in FIG. 11). Integrated into the backbone plate assembly 212 are a pair of guides 225 (shown in FIG. 16A). The guides 225 assist in controlling the movement of the stripper backbone assembly 210, and thereby the plurality of stripper assemblies 54 attached thereto, relative to the rotor shield 216 and a stripper axis 236 (shown in FIG. 15). The backbone plate assembly 212 comprises one or more plates that form an arcuate surface, forming a backbone trough 248. The backbone plate assembly 212 may facilitate improved control of crop material positioning after the crop material is received by the crop pick-up device 20.

Movement of the backbone plate assembly 212 and the plurality of stripper assemblies 54 of the stripper backbone assembly 210 between a baling configuration (shown in FIGS. 10, 17, and 18), in which each stripper assembly 54 is positioned during baling operation, and a release configuration (shown in FIGS. 19 and 21). In the release configuration, the movement of the backbone plate assembly 212 creates more space around the first and second augers 50, 51 and the entrance 19 to the bale formation chamber 12 to facilitate increased crop material movement to prevent and/or clear plugging.

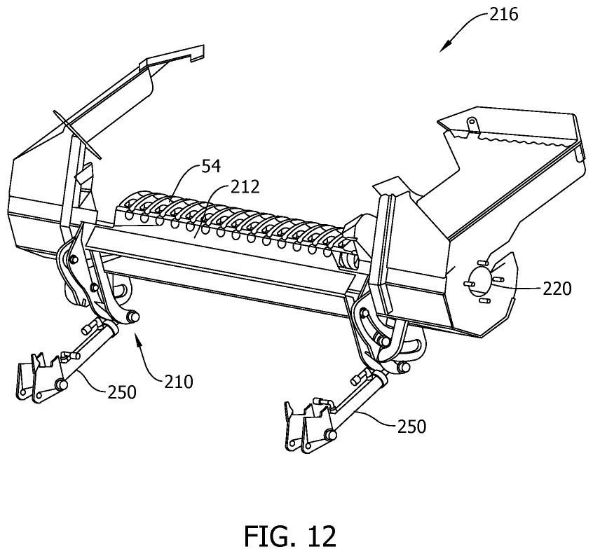

FIGS. 11 and 12 are perspective views of the rotor shield 216, the stripper backbone assembly 210, and the plurality of stripper assemblies 54. FIGS. 13 and 14 are partial perspective views of the rotor shield 216. The rotor shield 216 includes a side panel having bearing mounts 220 which define a rotor axis 222 and are oriented and configured to support bearings that support the rotor assembly 40. The rotor shaft 44 (shown in FIG. 3A) is mounted to the rotor side panel at a bearing mount 220 on each end of the rotor shaft 44. The rotor shield 216 also includes a pair of guide plates 214, each guide plate 214 oriented perpendicular to the rotor axis 222 and including a guide slot 224 defined by a pair of arcuate surfaces 226, 228. The arcuate surfaces 226, 228 are each positioned on a circle with a center intersected by the rotor axis 222, with a portion of the perimeter of the circle being at a mid-point between the arcuate surfaces 226, 228 at a guide radius 232. The guide radius 232 is defined as the distance between the rotor axis 222 and the perimeter of the circle. The guide plates 214 are separated by a guide width 234.

FIG. 15 is a side perspective view, and FIGS. 16A and 16B are perspective views, of the stripper backbone assembly 210. Each stripper assembly 54 of the rotor assembly 40 is mounted to the backbone plate assembly 212. Each stripper assembly 54 is positioned such that the spaces 52 (shown in FIG. 4) between adjacent stripper assemblies 54 are aligned along a stripper axis 236 that passes through the center of each opening 75 of each stripper assembly 54, with the openings 75 being aligned by the rotor shaft 44. The stripper axis 236 is coaxial with the rotor axis 222. Each of the guide plates 214 (shown in FIG. 14) are oriented to support the backbone plate assembly 212 by means of the guides 225, as further described below. The stripper assembly 54, as shown in the Figures, is intended to be an embodiment of a stripper for use with a forage harvest machine. Thus, other embodiments of a stripper may be used with a stripper backbone assembly 210 of a forage harvest machine, such as, but not limited to, the round baler 200.

The guides 225 of the backbone plate assembly 212 provide a mounting location for one or more roller supports 238 which, when assembled onto rotor shield 216, are positioned within the guide slot 224 of the guide plates 214. In the illustrated embodiment, two roller supports 238 are positioned on each side of the stripper backbone assembly 210. The roller supports 238 are mounted to the backbone plate assembly 212 and rotate freely about a roller support axis 240 that is parallel to the stripper axis 236. The distance between the roller support axis 240 and the stripper axis 236 is substantially equivalent to the guide radius 232 (shown in FIG. 13). Each roller support 238 may have a diameter that is substantially equivalent to the distance between the two arcuate surfaces 226, 228 of the guide slot 224. such that the roller support 238 may move along the guide slot 224.

The backbone plate assembly 212 includes support surfaces 242. In the illustrated embodiment, the support surfaces 242 are circular and are concentric with the roller supports 238. In other embodiments, the support surfaces 242 may be positioned separately from the roller supports 238. The support surfaces 242 are separated by a distance 244 (shown in FIG. 16). The distance 244 may be slightly less than the guide width 234 (shown in FIG. 14) such that the support surfaces 242 of the backbone plate assembly 212 fit between the guide plates 214.

Once the backbone plate assembly 212 is positioned between the guide plates 214, the roller supports 238 are mounted to the backbone plate assembly 212 and engaged with the guide slots 224. The backbone plate assembly 212, and thus the stripper assemblies 54 that are mounted to the backbone plate assembly 212, may move relative to the rotor shield 216 (FIG. 12) about the stripper axis 236 (shown in FIG. 15). The movement of the backbone plate assembly 212 and the plurality of stripper assemblies 54 relative to the rotor shield 216 facilitate reduced plugging and/or improved clearing of crop material.

FIGS. 17-19 are schematic views of the rotor assembly 40. As crop material is received by the crop pick-up device 20 and conveyed towards the bale formation chamber 12, the crop material plug 260 may form proximate the plurality of teeth 48 of the rotor assembly 40. For example, the crop material plug 260 may form and become lodged between the rotor assembly 40, rotating clockwise, and baler starter roller 22, also rotating clockwise. As shown in FIG. 17, the crop material plug 260 prevents crop material from flowing freely into the bale formation chamber 12. While the crop material plug 260 is illustrated in the Figures as circular, this is intended to be illustrative and is not meant to limit crop material plug to having a circular shape.

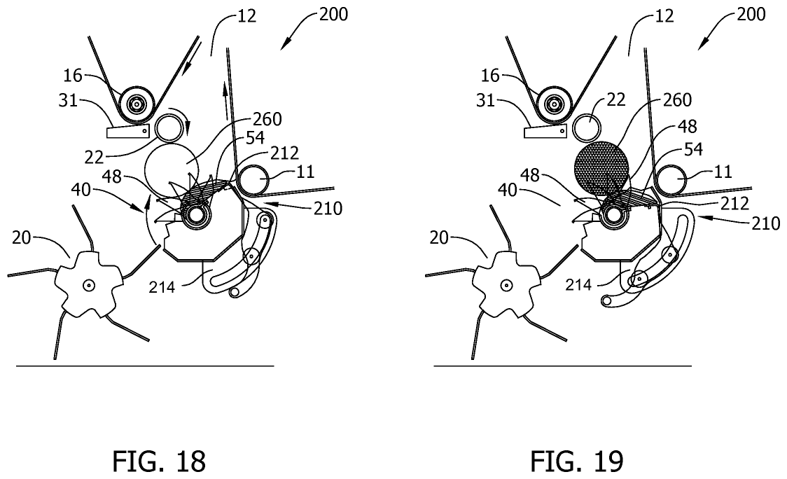

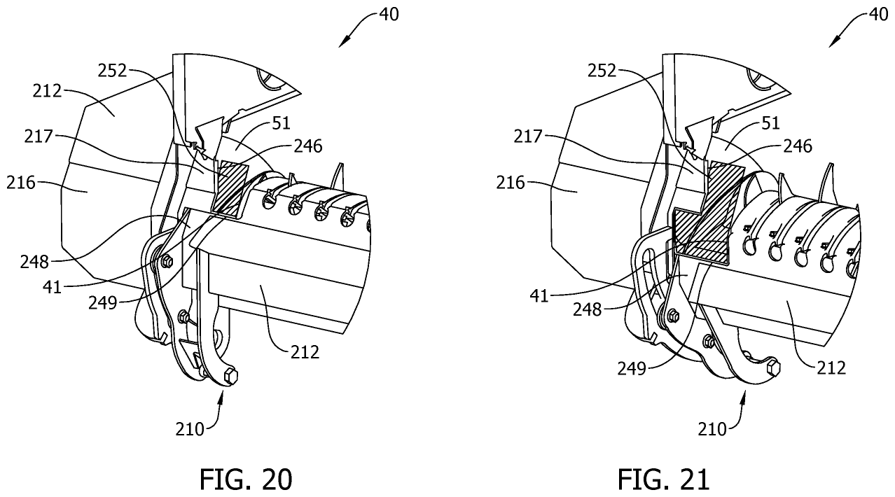

The baling configuration of the stripper backbone assembly 210 is shown in FIG. 18. In the baling configuration, the backbone plate assembly 212 is supported by a pair of stripper backbone positioning cylinders 250 (shown in FIG. 12 in a retracted position). When the round baler 200 is operating in the baling configuration, the plurality of stripper assemblies 54 effectively force crop material to disengage from the rotor assembly 40 as the crop material is conveyed into the bale chamber. Thus, the crop material plug 260 may form and become wedged between the baler starter roller 22 (and/or the starter roller scraper 31) and the rotor assembly 40, which may impede and/or stop the rotation of the baler starter roller 22 and/or the rotor assembly 40.

The release configuration of the stripper backbone assembly 210 is shown in FIG. 19. In the release configuration, the pair of stripper backbone positioning cylinders 250 (shown in FIG. 12 in a retracted position) are extended to support and move the backbone plate assembly 212, and thus the plurality of stripper assemblies 54, about the stripper axis 236. The movement of the backbone plate assembly 212, and thus the plurality of stripper assemblies 54, about the stripper axis 236 increases the space between an upper edge of the stripper assemblies 54 of the rotor assembly 40 and the baler starter roller 22 (and/or the starter roller scraper 31), facilitating improved engagement by the plurality of teeth 48 of the crop material plug 260 and increasing the size of the entrance 19 to the bale formation chamber 12. That is, the increased space between the stripper assemblies 54 of the rotor assembly 40 and the baler starter roller 22 facilitates improved movement of crop material as it is conveyed into the bale formation chamber 12, thereby reducing crop material plugging and improving movement of any crop material plugging that may have formed.

FIGS. 20 and 21 are perspective front views of the rotor assembly 40 of the round baler 200. The baling configuration of the stripper backbone assembly 210 is shown in FIG. 20. While only one side of the round baler 200 is shown in FIGS. 20 and 21, it should be understood that the elements as illustrated in FIGS. 20 and 21 are present on both sides of the round baler 200. The second auger 51 of the rotor assembly 40 is positioned within the first trough 217 and the backbone trough 248 (shown in FIGS. 20 and 21), and the first auger 50 is positioned within the second trough 218 (not shown in FIGS. 20 and 21) and the backbone trough 248. The first trough 217 is formed in the rotor shield 124 and the backbone trough 248 is formed in the backbone plate assembly 212.

In the baling configuration, the first trough 217 and the backbone trough 248 are positioned adjacently, with the stripper backbone positioning cylinders 250 in a retracted position, to form a continuous trough that extends from a trough edge 246 to a trough ledge 249. The trough edge 246 is formed by an edge of the rotor shield 216 and the trough ledge 249 is formed by an edge of the backbone plate assembly 212, defining an auger discharge pocket 252. As the first and second augers 50, 51 propel crop material axially inward, the crop material passes through the auger discharge pocket 252 as it is conveyed into the bale formation chamber 12. The auger discharge pocket has an open top and is at least partially defined by the first side 41 of the rotor assembly 40 (shown in FIG. 20).

The release configuration of the backbone assembly 210 is shown in FIG. 21. In the release configuration, the backbone trough 248 is moved away from the first trough 217 to lower the trough ledge 249 and thereby increase the size of the auger discharge pocket 252. The increased size of the auger discharge pocket 252 facilitates the movement of crop material lodged in the auger discharge pocket 252 into the bale formation chamber 12 and/or back onto the ground below the round baler 200. Thus, the increased size of the auger discharge pocket 252 in the release configuration facilitates improved movement of crop material out of the auger discharge pocket 252 for reduced crop material plugging.

This written description uses examples to disclose the invention, including the best mode and to enable a person of ordinary skill in the relevant art to make and practice the invention, including making and using any devices or systems and performing any incorporated methods. The patentable scope of the invention is defined by the claims. Such other examples are within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

As various changes could be made in the above constructions and methods without departing from the scope of the disclosure, it is intended that all matter contained in the above description and shown in the accompanying drawings shall be interpreted as illustrative and not in a limiting sense.

1. A forage harvest machine comprising:
a crop pick-up device;
a rotor assembly that rotates about a rotor axis, the rotor assembly comprising:
a rotor shaft;
a plurality of teeth attached to the rotor shaft for rotation in a teeth rotation area; and
one or more augers for directing crop material inward toward the plurality of teeth; and
one or more plates radially outward from the teeth rotation area, the one or more plates forming a first trough and a second trough in which each of the one or more augers is at least partially disposed, at least one of the first and second troughs being moveable relative to the other trough to adjust sizing of an auger discharge pocket.

2. The forage harvest machine of claim 1, wherein the one or more augers comprises a first auger positioned at a first end of the rotor shaft and a second auger positioned at a second end of the rotor shaft opposite the first end.

3. The forage harvest machine of claim 1, further comprising:
a bale formation chamber comprising an entrance through which crop material picked up by the crop pick-up device is received into the bale formation chamber
a rotor shield that supports the rotor assembly, the rotor shield comprising the first trough; and
a stripper backbone assembly comprising a backbone plate assembly and a plurality of stripper assemblies connected to the backbone plate assembly, the stripper backbone assembly comprising the second trough,
wherein the second trough is moveable relative to the first trough to adjust sizing of the auger discharge pocket.

4. The forage harvest machine of claim 3, wherein the plurality of stripper assemblies rotate about a stripper axis as the second trough moves relative to the first trough.

5. The forage harvest machine of claim 3, wherein a width of the crop pick-up device is greater than a width of the entrance of the bale formation chamber, the one or more augers being positioned laterally outwards of the entrance of the bale formation chamber.

6. The forage harvest machine of claim 1, further comprising one or more guides that enable one of the first and second trough to move relative to the other trough.

7. The forage harvest machine of claim 6, wherein each of the one or more guides comprise a guide plate and a roller support.

8. The forage harvest machine of claim 7, wherein the guide plate comprises a guide plate slot, the roller support being oriented to move within the guide plate slot.

9. The forage harvest machine of claim 8, wherein the one or more guides comprises a first guide plate and a second guide plate.

10. The forage harvest machine of claim 1, further comprising a bale formation chamber comprising an entrance through which crop material picked up by the crop pick- up device is received into the bale formation chamber, wherein downward movement of one or more plates increases an area defined by the entrance of the bale formation chamber.

11. The forage harvest machine of claim 10, wherein downward movement of the second trough facilitates increased engagement of the crop material by the plurality of teeth of the rotor assembly.

12. The forage harvest machine of claim 10, wherein the area defined by the entrance of the bale formation chamber is increased by increasing a distance between a plurality of stripper assemblies of a stripper backbone assembly and at least one of a roller defining the bale formation chamber or a scraper proximate the roller defining the bale formation chamber.

13. A forage harvest machine comprising:
a crop pick-up device;
a bale formation chamber comprising an entrance through which crop material picked up by the crop pick-up device is received into the bale formation chamber;
a rotor assembly that rotates about a rotor axis, the rotor assembly comprising a plurality of teeth;
a plurality of stripper assemblies connected to a backbone plate assembly, each of the plurality of stripper assemblies having an opening aligned along a stripper axis;
a rotor shield that supports the rotor assembly; and
a pair of guide plates, each of the pair of guide plates being oriented to enable the backbone plate assembly to move relative to the rotor shield.

14. The forage harvest machine of claim 13, wherein a width of the crop pick-up device is greater than a width of the entrance of the bale formation chamber.

15. The forage harvest machine of claim 13, wherein each of the pair of guide plates comprise a guide plate slot, the guide plate slots having an arcuate center that is intersected by the rotor axis.

16. The forage harvest machine of claim 13, wherein downward movement of the backbone plate reter assembly increases an area defined by the entrance of the bale formation chamber.

17. The forage harvest machine of claim 13, wherein downward movement of the backbone plate retor assembly facilitates increased engagement of the crop material by the plurality of teeth of the rotor assembly.

18. The forage harvest machine of claim 17, wherein an area defined by the entrance of the bale formation chamber is increased by increasing a distance between the plurality of stripper assemblies and one or more components positioned above the plurality of stripper assemblies.

19. The forage harvest machine of claim 18, wherein the distance is increased between the plurality of stripper assemblies and a roller defining the bale formation chamber.

20. The forage harvest machine of claim 18, wherein the distance is increased between the plurality of stripper assemblies and a scraper proximate a roller defining the bale formation chamber.
